(19) United States
(12) Patent Application Publication
(10) Pub. No.: US 2025/0192644 A1
(43) Pub. Date: Jun. 12, 2025

(54) DRIVING UNIT OF WEARABLE DEVICE

(71) Applicant: Samsung Electronics Co., Ltd., Suwon-si (KR)

(72) Inventor: Yonghyun PARK, Suwon-si (KR)

(21) Appl. No.: 19/057,694

(22) Filed: Feb. 19, 2025

Related U.S. Application Data
(63) Continuation of application No. PCT/KR2023/012854, filed on Aug. 30, 2023.

(30) Foreign Application Priority Data
Oct. 25, 2022 (KR) 10-2022-0138278

(51) Int. Cl. H02K 9/18; A61H 3/00; H02K 11/24

(52) U.S. Cl. CPC H02K 9/18; A61H 3/00; H02K 11/24; A61H 2003/007

(57) ABSTRACT

A driving unit of a wearable device (e.g., walking assist device) may include: an auxiliary frame capable of supporting a user's body so as to assist the body movement of a user; a motor housing capable of accommodating a motor capable of supplying power to the auxiliary frame; and a heat dissipation channel capable of discharging heat generated from the motor to the outside of the motor housing.

### CROSS-REFERENCE TO RELATED APPLICATIONS

This application is a continuation application of International Application No. PCT/KR2023/012854 designating the United States, filed on Aug. 30, 2023, in the Korean Intellectual Property Receiving Office and claiming priority to Korean Patent Application No. 10-2022-0138278, filed on Oct. 25, 2022, the disclosures of which are all hereby incorporated by reference herein in their entireties.

### BACKGROUND

### TECHNICAL FIELD

Certain example embodiments relate to a driving unit of a wearable device, a power supply unit of the wearable device, and/or the wearable device including the same.

### DESCRIPTION OF RELATED ART

A motion assistance device refers to a mechanism or device that helps a patient, who cannot walk on his own due to various diseases, accidents, and the like, to perform exercises for rehabilitation treatment, and/or to a device or mechanism that helps a user exercise such as walk or the like. With the recent intensifying aging societies, a growing number of people experience inconvenience in motions or have difficulty in normal motions due to malfunctioning joint issues, and there is increasing interest in motion assistance devices. A motion assistance device is mounted on a body of a user to assist the user with motions by providing a necessary muscular strength and to induce the user to walk to perform normal motions, and/or to help a person exercise.

Furthermore, the motion assistance device may provide appropriate resistance force when the user performs strength training, thereby assisting with strength training of the user according to the needs of the user.

In general, motion assistance devices involve the inevitable heating of some components in the process of providing assistance force or resistance force to assist with motions of users. Therefore, motion assistance devices capable of effectively controlling heat generation are required.

The above description is information the inventor(s) acquired during the course of conceiving the present disclosure, or already possessed at the time, and is not necessarily art publicly known before the present application was filed.

### SUMMARY

An example embodiment provides a driving unit of a wearable device capable of effectively discharging heat generated by a motor and a circuit heating element to the outside.

An example embodiment provides a power supply unit of a wearable device (e.g., walking assist device) capable of effectively discharging heat generated by a battery and a resistor to the outside.

An example embodiment provides a wearable device capable of preventing or reducing moisture from penetrating from the outside.

A driving unit of a wearable device according to an embodiment may include an auxiliary frame capable of supporting a body of a user to assist with a body motion of the user, a motor housing capable of accommodating a motor capable of supplying power to the auxiliary frame therein, and a heat dissipation channel capable of discharging heat generated from the motor to the outside of the motor housing.

The heat dissipation channel may include a plurality of heat dissipation plates spaced apart at predetermined intervals, and air may flow between the plurality of heat dissipation plates.

The auxiliary frame may be rotatably connected, directly or indirectly, to one side of the motor housing, and the heat dissipation channel may be positioned on the other side of the motor housing.

The heat dissipation channel may include a heat dissipation frame surrounding the motor in the motor housing, and a plurality of heat dissipation plates extending from the heat dissipation frame to the outside of the motor housing and spaced apart at predetermined intervals.

The heat dissipation frame may transmit the heat generated from the motor to the heat dissipation plates, and the heat dissipation plates may be capable of discharging the heat received from the heat dissipation frame into the air.

The driving unit of the wearable device according to an example embodiment may further include a heat dissipation plate housing enclosing the heat dissipation plates, wherein the heat dissipation plate housing and the motor housing may be connected integrally.

The heat generated from the motor may be discharged to one side of the motor housing through a metal gear connecting the motor and the auxiliary frame and discharged to the other side of the motor housing through the heat dissipation channel.

The auxiliary frame may include a metal torque sensor connected, directly or indirectly, to the metal gear, and the heat generated from the motor may be transmitted to the metal torque sensor through the metal gear.

The auxiliary frame and the metal torque sensor may be formed integrally to prevent or reduce chances of moisture from penetrating from the outside.

A power supply unit of a wearable device according to an example embodiment may include a waist plate capable of supporting a lower back of a user, a battery housing accommodating a battery and a resistor capable of supplying and controlling power to the driving unit of the wearable device, and/or a heat dissipation channel capable of discharging heat generated from the battery and the resistor to the outside of the battery housing.

The heat dissipation channel may include a plurality of heat dissipation plates spaced apart at predetermined intervals, and air may flow between the plurality of heat dissipation plates.

A wearable device according to an example embodiment may include the driving unit of the wearable device, the power supply unit, and/or a main frame unit capable of connecting the driving unit of the wearable device and the power supply unit of the wearable device and accommodating a body of a user therein.

A driving unit of a wearable device according to an example embodiment may effectively discharge heat generated by a motor to the outside.

A power supply unit of a wearable device according to an example embodiment may effectively discharge heat generated by a battery and a resistor to the outside.

A wearable device according to an example embodiment may prevent or reduce moisture from penetrating from the outside. A wearable device according to an example embodiment may be designed and positioned inside a product design so that a heat dissipation channel for heat dissipation is not exposed to the outside.

### BRIEF DESCRIPTION OF DRAWINGS

FIG. 1 illustrates a wearable device according to an example embodiment.

FIG. 2 illustrates a driving unit of a wearable device according to an example embodiment.

FIG. 3 illustrates a heat dissipation process of heat dissipation plates of a driving unit of a wearable device according to an example embodiment.

FIG. 4 illustrates the shape of an auxiliary frame of a driving unit of a wearable device according to an example embodiment.

FIG. 5 illustrates a power supply unit of a wearable device according to an example embodiment.

FIG. 6 illustrates a heat dissipation process of heat dissipation plates of a power supply unit of a wearable device according to an example embodiment.

### DETAILED DESCRIPTION

Hereinafter, example embodiments will be described in detail with reference to the accompanying drawings. The following description is one of various aspects of the embodiments, and the description below forms part of the detailed description of the embodiments. In describing an embodiment, a detailed description of known functions or configurations may be omitted.

However, various alterations and modifications may be made to the embodiments. Thus, the embodiments are not meant to be limited by the descriptions of the present disclosure. The embodiments should be understood to include all changes, equivalents, and replacements within the idea and the technical scope of the disclosure.

In addition, the terms or words used to describe the present disclosure and claims should not be construed in a conventional or dictionary meaning, and based on a principle that the inventor may properly define the concept of terms, the terms or words should be construed as having meanings and concepts consistent with the technical idea of the disclosure according to an embodiment.

The singular forms “a”, “an”, and “the” are intended to include the plural forms as well, unless the context clearly indicates otherwise. It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or groups thereof.

Unless otherwise defined, all terms including technical and scientific terms used herein have the same meaning as commonly understood by one of ordinary skill in the art to which the embodiments belong. Terms defined in dictionaries generally used should be construed as having meanings matching contextual meanings in the related art and are not to be construed as having an ideal or excessively formal meaning unless otherwise defined herein.

When describing the embodiments with reference to the accompanying drawings, like reference numerals refer to like components and a repeated description related thereto will be omitted. In the description of embodiments, detailed description of well-known related structures or functions will be omitted when it is deemed that such description will cause ambiguous interpretation of the present disclosure.

Also, in the description of the components, terms such as first, second, A, B, (a), (b) or the like may be used herein when describing components of the present disclosure. These terms are used only for the purpose of discriminating one component from another component, and the nature, the sequences, or the orders of the components are not limited by the terms. It should be noted that if one component is described as being “connected,” “coupled” or “joined” to another component, the former may be directly “connected,” “coupled,” and “joined” to the latter or “connected”, “coupled”, and “joined” to the latter via another component(s). Thus, “connected” as used herein covers both direct and indirect connections.

The same name may be used to describe an element included in the embodiments described above and an element having a common function. Unless otherwise mentioned, the descriptions of the examples may be applicable to the following examples and thus, duplicated descriptions will be omitted for conciseness.

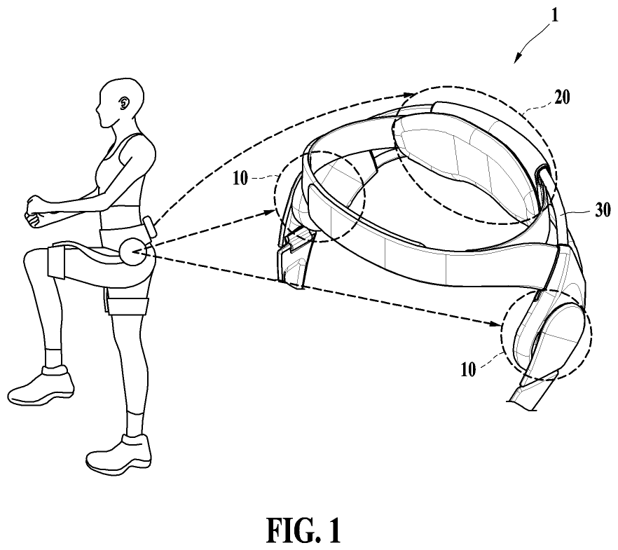

FIG. 1 illustrates a wearable device according to an embodiment.

Referring to FIG. 1, a wearable device 1 according to an embodiment may include driving units 10, a power supply unit 20, and a main frame unit 30.

The driving units 10 may support at least one portion of the body of a user to assist with a body motion of the user. For example, the driving units 10 may support the legs of the user to assist the user in walking. For example, the driving units 10 may support a portion of the body of the user and transmit resistance force or assistance force to the portion of the body of the user. The driving units 10 may each include an auxiliary frame mounted on the body of the user and capable of assisting the body of the user, and a motor capable of transmitting power to the auxiliary frame. “Mounted on” as used herein covers both directly and indirectly on.

The power supply unit 20 may supply power to the driving units 10. The power supply unit 20 may supply power to the motors of the driving units 10 and control the drive of the motors so that the motors of the driving units 10 may transmit preset assistance force and resistance force to the body of the user. The power supply unit 20 may be positioned on the lower back of the user while the user is wearing the wearable device. The power supply unit 20 may include a waist plate that is in contact with the lower back of the user and supports the lower back of the user. The power supply unit 20 may include a battery capable of supplying power to the motors of the driving units 10, and a resistor (e.g., an electrical resistor) capable of controlling the motors of the driving units 10.

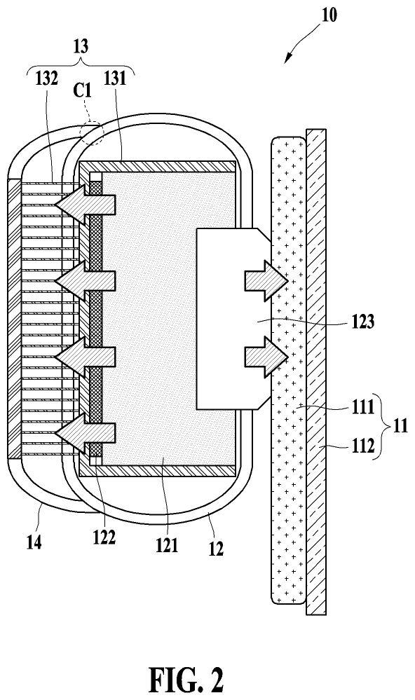

FIG. 2 illustrates a driving unit of a wearable device according to an embodiment.

Referring to FIG. 2, a driving unit 10 of the wearable device according to an embodiment may include an auxiliary frame 11, a motor housing 12, a heat dissipation channel 13, and a heat dissipation plate housing 14.

The auxiliary frame 11 may support the body of a user to assist with a body motion of the user. The auxiliary frame 11 may be mounted on a portion of the body of the user to assist with a body motion of the user. The auxiliary frame 11 may be mounted, for example, on a leg portion of the user. The auxiliary frame 11 may be rotatably connected, directly or indirectly, to the motor housing 12. The auxiliary frame 11 may be connected, directly or indirectly, to the motor housing 12 through a metal gear 123. The auxiliary frame 11 may include an auxiliary frame body 112, and a metal torque sensor 111 connected, directly or indirectly, to one surface of the auxiliary frame body 112. The metal torque sensor 111 may be connected, directly or indirectly, to the metal gear 123.

The motor housing 12 may accommodate the motor 121 therein. The motor housing 12 may rotatably support the auxiliary frame 11. The motor 121 accommodated in the motor housing 12 may transmit driving force to the auxiliary frame 11 through the metal gear 123. The driving force from the motor 121 may be transmitted through the metal gear 123 to the metal torque sensor 111 of the auxiliary frame 11. The torque sensor 111 receiving the driving force from the motor 121 through the metal gear 123 may rotate with respect to the motor housing 12 integrally with the auxiliary frame body 112. The motor 121 may rotate the auxiliary frame 11 with respect to the motor housing 12.

The auxiliary frame 11 may be positioned on one side of the motor housing 12. The heat generated by the motor 121 in the motor housing 12 may be discharged to one side of the motor housing 12 through the metal gear 123 and the metal torque sensor 111. The metal gear 123 connected, directly or indirectly, to one side of the motor 121 may be formed of a metal material (e.g., aluminum) for easy transmission of the heat generated from the motor 121. The metal torque sensor 111 of the auxiliary frame 11 connected, directly or indirectly, to the metal gear 123 may be formed of a metal material, like the metal gear 123, thereby efficiently discharging the heat generated from the motor 121 to one side. The heat generated from the motor 121 may be transmitted through the metal gear 123 to the metal torque sensor 111 and then be dissipated into the air from the metal torque sensor 111.

The auxiliary frame 11 may be positioned on one side of the motor housing 12, and the heat dissipation channel 13 may be formed on the other side of the motor housing 12. The heat generated from the motor 121 may be dissipated to one side through the metal gear 123 and the metal torque sensor 111 of the auxiliary frame connected, directly or indirectly, to the metal gear 123, and dissipated to the other side through the heat dissipation channel 13. The heat generated from the motor 121 in the motor housing 12 may be discharged to one side and the other side of the motor housing 12 through the metal gear 123 and the heat dissipation channel 13, respectively. The heat generated from the motor 121 in the motor housing 12 may be dissipated to both sides of the motor housing 12, whereby the temperature in the motor housing 12 may be maintained appropriately. For example, the temperature in the motor housing 12 may be maintained at 40 degrees Celsius, preferably under 38 degrees Celsius.

The heat dissipation channel 13 may include a heat dissipation frame 131 and a heat dissipation plate 132. The heat dissipation frame 131 may be disposed inside the motor housing 12 and formed to surround at least a portion of the motor 121 in the motor housing 12. The heat dissipation frame 131 may transmit the heat generated from the motor 121 to the heat dissipation plate 132 positioned on the other side of the motor housing 12. A thermally conductive layer 122 may be formed between the heat dissipation frame 131 and the motor 121 to effectively transmit the heat generated from the motor 121 to the heat dissipation frame 131. The thermally conductive layer 122 may be formed, for example, of thermal interface material (TIM) which is a thermally conductive material. The thermally conductive layer 122 may transmit the heat of the motor 121 to the heat dissipation frame 131. The heat dissipation frame 131 may be formed of a metal material, for example, for easy transmission of the heat generated from the motor 121 to the heat dissipation plate 132. The heat dissipation frame 131 may be connected, directly or indirectly, to the heat dissipation plate 132. The heat dissipation frame 131 may be formed integrally with the heat dissipation plate 132.

The heat dissipation plate 132 may be disposed on the other side of the motor housing 12. The heat dissipation plate 132 may be disposed in the opposite position to the auxiliary frame 12 based on the motor housing 11. For example, the motor housing 12 may be positioned between the heat dissipation plate 132 and the auxiliary frame 11. The heat dissipation plate 132 may be formed in plurality. The plurality of heat dissipation plates 132 may be spaced apart at preset intervals. The plurality of heat dissipation plates 132 may be formed so that the contact area with air may be maximized. The heat dissipation plates 132 may be extended from the heat dissipation frame 131.

The heat dissipation plates 132 may receive the heat of the motor 121 from the heat dissipation frame 131. The heat dissipation plates 132 may receive the heat of the motor 121 from the heat dissipation frame 131 and discharge the heat into the air. Outside air may flow between the plurality of heat dissipation plates 132. As outside air flows between the plurality of heat dissipation plates 132, the heat of the motor 121 may be diffused to the outside through the heat dissipation plates 132. One end portion of each of the plurality of heat dissipation plates 132 may be connected, directly or indirectly, to the heat dissipation frame 131. For example, the heat dissipation plates 132 may be formed integrally with the heat dissipation frame 131. Each of the heat dissipation plates 132 may penetrate through one side of the motor housing 12 and be connected, directly or indirectly, to the heat dissipation frame 131. The heat dissipation plates 132 may be formed in a shape extending outward from the heat dissipation frame 131.

The driving unit of the wearable device according to an embodiment may further include the heat dissipation plate housing 14 surrounding the plurality of heat dissipation plates 132. The heat dissipation plate housing 14 may be positioned closest to the body of the user (e.g., a femoral region of the user) while the user is wearing the wearable device. The heat dissipation plate housing 14 may cover the heat dissipation plates 142 so that a portion of the body of the user may not come in direct contact with the heat dissipation plates. The heat dissipation plate housing 14 may be formed to be connected, directly or indirectly, to the motor housing 12. For example, the heat dissipation plate housing 14 may be formed integrally with the motor housing 12. As the heat dissipation plate housing 14 is formed by being connected integrally with the motor housing 12, a connecting portion cl of the motor housing 12 and the heat dissipation plate housing 14 may be formed in a shape that continues without a gap, and the open area that allows air to flow through and from the upper and lower sides of the heat dissipation plate housing may be adjusted as needed.

The shape of the motor housing 12 and heat dissipation plate housing 14, which are formed integrally, may shield the inflow of moisture from the outside. Therefore, the structure of the heat dissipation plate housing 14 and the motor housing 12, which are formed integrally, may prevent or reduce a chance of moisture from penetrating the driving unit of the wearable device. The plurality of heat dissipation plates 132 may be provided inside the heat dissipation plate housing 14. The heat dissipation plates 132 may extend from the heat dissipation frame 131 inside the motor housing 12 to the inner side surface of the heat dissipation plate housing 14.

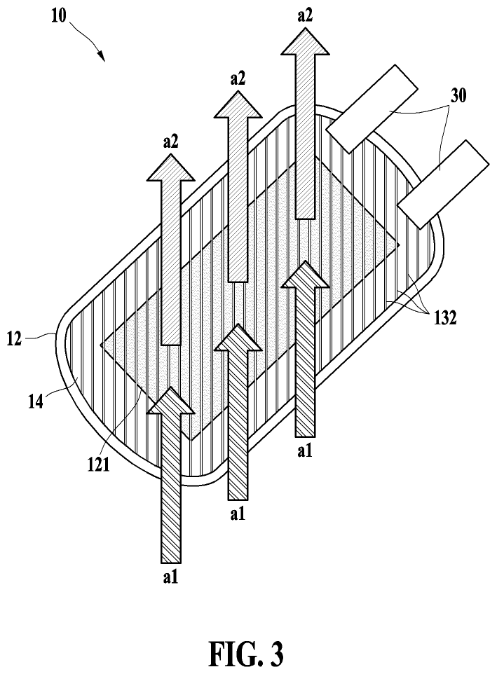

FIG. 3 illustrates a heat dissipation process of heat dissipation plates of a driving unit of a wearable device according to an embodiment.

Referring to FIG. 3, the heat dissipation plate 132 of the driving unit 10 of the wearable device according to an embodiment may be formed in plurality to be spaced apart at preset intervals. As air flows between the plurality of heat dissipation plates 132 spaced apart from each other, the heat of the motor 121 in the motor housing 12 may be dissipated. The heat dissipation plate housing 14 may be formed on one side of the motor housing 12, and may be formed integrally with the motor housing 12. The heat dissipation plate housing 14, which is connected integrally with the motor housing 12, may prevent or reduce external moisture from penetrating the driving unit of the wearable device. The main frame unit 30 may be connected, directly or indirectly, to one end portion of the motor housing 12.

When outside air flows between the plurality of heat dissipation plates 132, the air may enter from one end portion of the heat dissipation plates 132 and exit through the other end portion. For example, air al in a first state may enter the plurality of heat dissipation plates 132, and the air al in the first state may flow in the longitudinal direction of the heat dissipation plates 132 between the plurality of heat dissipation plates 132. For example, the air al in the first state may have the same temperature as the air in the atmosphere. The air al in the first state flowing in the longitudinal direction of the heat dissipation plates 132 may receive the heat of the motor 121 from the heat dissipation plates 132. The air al in the first state, which flows in the longitudinal direction of the heat dissipation plates 132 and receives the heat of the motor 121 from the heat dissipation plates 132, may increase in temperature, and may escape the heat dissipation plates 132 as air a2 in a second state having a higher temperature than the air al in the first state. The heat of the motor 121 may be transmitted to the outside by the outside air flowing between the heat dissipation plates 132.

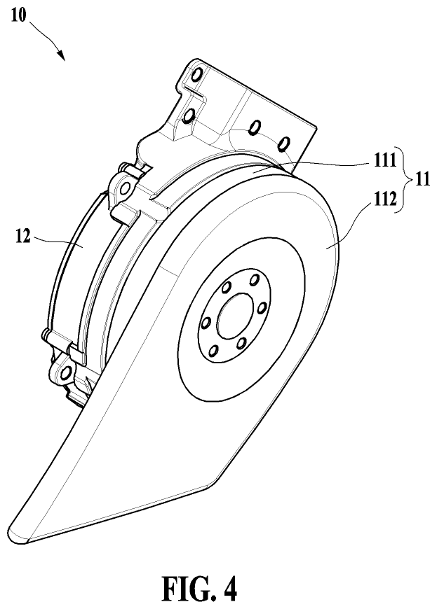

FIG. 4 illustrates the shape of an auxiliary frame of a driving unit of a wearable device according to an embodiment.

Referring to FIG. 4, a driving unit 10 of the wearable device according to an embodiment may include a motor housing 12 and an auxiliary frame 11.

The motor housing 12 and the auxiliary frame 11 may be mechanically connected, directly or indirectly.

The auxiliary frame 11 may support the body of a user to assist with a body motion of the user. The auxiliary frame 11 may be mounted on a portion of the body of the user to assist with a body motion of the user. The auxiliary frame 11 may be mounted, for example, on a leg portion of the user. The auxiliary frame 11 may be rotatably connected, directly or indirectly, to the motor housing 12. The auxiliary frame 11 may be connected to the motor housing 12 through a metal gear. The auxiliary frame 11 may include an auxiliary frame body 112, and a metal torque sensor 111 connected to one surface of the auxiliary frame body 112. The metal torque sensor 111 may be connected to the metal gear. “On” as used herein covers both directly and indirectly on.

The motor housing 12 may accommodate a motor therein. The motor provided in the motor housing 12 may transmit power to the auxiliary frame 11. The motor housing 12 may rotatably support the auxiliary frame 11. The driving force from the motor 121 may be transmitted through the metal gear 123 to the metal torque sensor 111 of the auxiliary frame 11. The metal torque sensor 111 receiving the driving force from the motor through the metal gear may rotate with respect to the motor housing 12 integrally with the auxiliary frame body 112. The motor provided in the motor housing 12 may rotate the auxiliary frame 11 with respect to the motor housing 12.

The auxiliary frame 11 may be positioned on one side of the motor housing 12. The heat generated by the motor in the motor housing 12 may be discharged to one side of the motor housing 12 through the metal gear and the metal torque sensor 111. The metal gear connected to one side of the motor may be formed of a metal material for easy transmission of the heat generated from the motor. The metal torque sensor 111 of the auxiliary frame 11 connected to the metal gear may be formed of a metal material, like the metal gear, thereby efficiently discharging the heat generated from the motor to one side. The heat generated from the motor may be transmitted through the metal gear to the metal torque sensor 111 and then be dissipated into the air from the metal torque sensor 111.

The metal torque sensor 111 and the auxiliary frame body 112 may be formed integrally. The metal torque sensor 111 may be mechanically connected to the auxiliary frame body 112. One surface of the metal torque sensor 111 and one surface of the auxiliary frame body 112 may be attached in contact with each other. If the metal torque sensor 111 and the auxiliary frame body 112 are formed integrally, the metal torque sensor 111 and the auxiliary frame body 112 may be formed of the same material. For example, the metal torque sensor 111 and the auxiliary frame body 112 may be a single rigid body including a metal material. As the metal torque sensor 111 and the auxiliary frame body 112 are formed integrally of a metal material, the heat transmitted from the motor in the motor housing 12 may be effectively discharged to the outside.

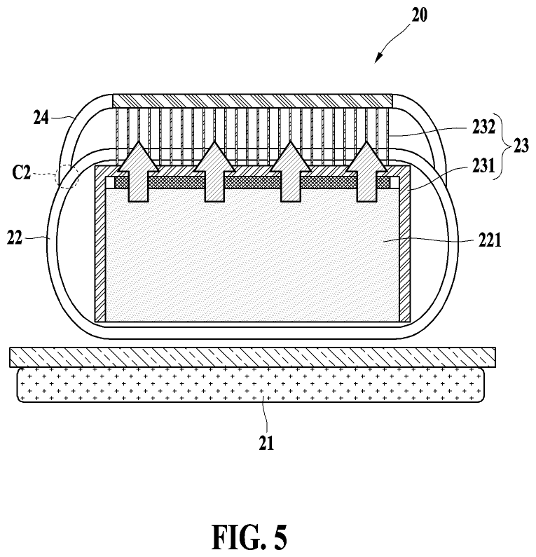

FIG. 5 illustrates a power supply unit of a wearable device according to an embodiment.

Referring to FIG. 5, the power supply unit 20 of the wearable device according to an embodiment may include a battery housing 22, a waist plate 21, and a heat dissipation channel 23.

The waist plate 21 may be positioned on the lower back of a user while the user is wearing the wearable device. The waist plate 21 may support the lower back of the user while the user is wearing the wearable device. The waist plate 21 may be mechanically connected to the battery housing 22. The battery housing 22 may be attached and secured to the waist plate 21.

The battery housing 22 may accommodate a battery and a resistor 221 therein. The battery and the resistor 221 accommodated in the battery housing 22 may supply power to the driving unit of the wearable device described above and control the motor of the driving unit. Specifically, the battery may exert electromotive force so that the motor of the driving unit may appropriately supply assistance force and resistance force to the body of the user. The resistor may exhaust back electromotive force generated by the motor of the driving unit. Heat may be generated in the battery and the resistor 221 in the process of supplying power to the motor and exhausting back electromotive force.

The heat dissipation channel 23 may be formed on one side of the battery housing 22. The heat generated from the battery and the resistor 221 may be dissipated to one side through the heat dissipation channel 23. The heat generated from the battery in the battery housing 22 and the resistor 221 on one side of the battery housing 22 may be dissipated to one side of the battery housing 22 through the heat dissipation channel 23, whereby the temperature in the battery housing 22 may be maintained appropriately. For example, the temperature in the battery housing 22 may be maintained at 40 degrees Celsius, preferably under 38 degrees Celsius.

The heat dissipation channel 23 may include a heat dissipation frame 231 and a heat dissipation plate 232. The heat dissipation frame 231 may be disposed inside the motor housing 22 and formed to surround at least a portion of the battery and the resistor 221 in the battery housing 22. The heat dissipation frame 231 may transmit the heat generated from the battery and the resistor 221 to the heat dissipation plate 232 positioned on one side of the battery housing 22. A thermally conductive layer may be formed between the heat dissipation frame 231 and the battery and the resistor 221 to effectively transmit the heat generated from the battery and the resistor 221 to the heat dissipation frame 231. The thermally conductive layer may be formed, for example, of thermal interface material (TIM) which is a thermally conductive material. The thermally conductive layer may transmit the heat of the battery and the resistor 221 to the heat dissipation frame 231. The heat dissipation frame 231 may be formed of a metal material, for example, for easy transmission of the heat generated from the battery and the resistor 221 to the heat dissipation plate 232. The heat dissipation frame 231 may be connected to the heat dissipation plate 232. The heat dissipation frame 231 may be formed integrally with the heat dissipation plate 232.

The heat dissipation plate 232 may be disposed on one side of the battery housing 22. The heat dissipation plate 232 may be disposed in the opposite position to the waist plate 21 based on the battery housing 22. For example, the battery housing 22 may be positioned between the heat dissipation plate 232 and the waist plate 21. The heat dissipation plate 232 may be formed in plurality. The plurality of heat dissipation plates 232 may be spaced apart at preset intervals. The plurality of heat dissipation plates 232 may be formed so that the contact area with air may be maximized. The heat dissipation plates 232 may be extended from the heat dissipation frame 231. The heat dissipation plates 232 may receive the heat of the battery and the resistor 221 from the heat dissipation frame 231. The heat dissipation plates 232 may receive the heat of the battery and the resistor 221 from the heat dissipation frame 231 and discharge the heat into the air. Outside air may flow between the plurality of heat dissipation plates 232. As outside air flows between the plurality of heat dissipation plates 232, the heat of the battery and the resistor 221 may be diffused to the outside through the heat dissipation plates 232. One end portion of each of the plurality of heat dissipation plates 232 may be connected to the heat dissipation frame 231. For example, the heat dissipation plates 232 may be formed integrally with the heat dissipation frame 231. Each of the heat dissipation plates 232 may penetrate through one side of the battery housing 22 and be connected to the heat dissipation frame 231. The heat dissipation plates 232 may be formed in a shape extending outward from the heat dissipation frame 231.

The power supply unit 20 of the wearable device according to an embodiment may further include a heat dissipation plate housing 24 surrounding the plurality of heat dissipation plates 232. The heat dissipation plate housing 24 may cover the heat dissipation plates 232 so that the heat dissipation plates 232 may not be exposed to the outside while the user is wearing the wearable device. The heat dissipation plate housing 24 may be formed to be connected to the battery housing 22. For example, the heat dissipation plate housing 24 may be formed integrally with the battery housing 22. As the heat dissipation plate housing 24 is formed by being connected integrally with the battery housing 22, a connecting portion c2 of the battery housing 22 and the heat dissipation plate housing 24 may be formed in a shape that continues without a gap. The shape of the battery housing 22 and heat dissipation plate housing 24, which are formed integrally, may shield the inflow of moisture from the outside. That is, the structure of the heat dissipation plate housing 24 and the battery housing 22, which are formed integrally, may prevent or reduce moisture from penetrating the driving unit of the wearable device. The plurality of heat dissipation plates 232 may be provided inside the heat dissipation plate housing 24. The heat dissipation plates 232 may extend from the heat dissipation frame 231 inside the battery housing 22 to the inner side surface of the heat dissipation plate housing 24.

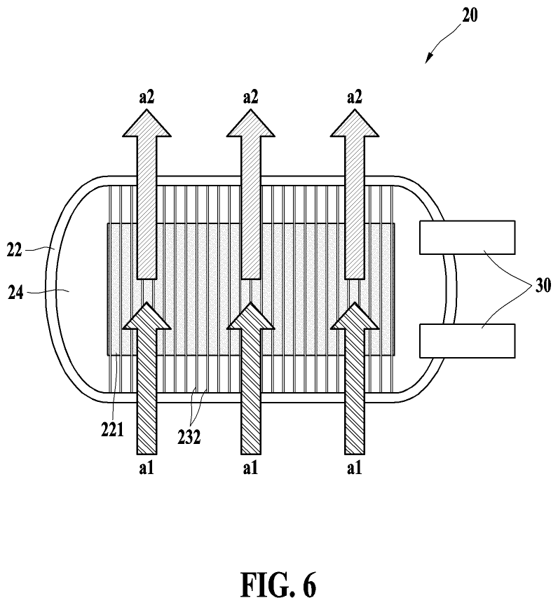

FIG. 6 illustrates a heat dissipation process of heat dissipation plates of a power supply unit of a wearable device according to an embodiment.

Referring to FIG. 6, the heat dissipation plate 232 of the power supply unit 20 of the wearable device according to an embodiment may be formed in plurality to be spaced apart at preset intervals. As air flows between the plurality of heat dissipation plates 232 spaced apart from each other, the heat of the battery and the resistor 221 in the battery housing 22 may be dissipated. The heat dissipation plate housing 24 may be formed on one side of the battery housing 22, and may be formed integrally with the battery housing 22. The heat dissipation plate housing 24, which is connected integrally with the battery housing 22, may prevent or reduce external moisture from penetrating the driving unit of the wearable device. The main frame unit 30 may be connected to one end portion of the battery housing 22. A main frame unit may also be formed at the other end portion of the battery housing 22 (not shown).

When outside air flows between the plurality of heat dissipation plates 232, the air may enter from one end portion of the heat dissipation plates 232 and exit through the other end portion. For example, air al in a first state may enter the plurality of heat dissipation plates 232, and the air al in the first state may flow in the longitudinal direction of the heat dissipation plates 232 between the plurality of heat dissipation plates 232. For example, the air al in the first state may have the same temperature as the air in the atmosphere. The air al in the first state flowing in the longitudinal direction of the heat dissipation plates 232 may receive the heat of the battery and the resistor 221 from the heat dissipation plates 232. The air al in the first state, which flows in the longitudinal direction of the heat dissipation plates 232 and receives the heat of the battery and the resistor 221 from the heat dissipation plates 232, may increase in temperature, and may escape the heat dissipation plates 232 as air a2 in a second state having a higher temperature than the air al in the first state. The heat of the battery and the resistor 221 may be transmitted to the outside by the outside air flowing between the heat dissipation plates 232.

While the disclosure has been illustrated and described with reference to various embodiments, it will be understood that the various embodiments are intended to be illustrative, not limiting. It will further be understood by those skilled in the art that various changes in form and detail may be made without departing from the true spirit and full scope of the disclosure, including the appended claims and their equivalents. It will also be understood that any of the embodiment(s) described herein may be used in conjunction with any other embodiment(s) described herein.

1. A driving unit of a wearable device, the driving unit comprising:
an auxiliary frame configured to support at least part of a body of a user to assist with a body motion of the user;
a motor housing configured to accommodate a motor for supplying power to the auxiliary frame; and
a heat dissipation channel configured to discharge heat generated from the motor to the outside of the motor housing.

2. The driving unit of the wearable device of claim 1, wherein the heat dissipation channel comprises a plurality of heat dissipation plates spaced apart at predetermined intervals, and is configured so that air can flow between the plurality of heat dissipation plates.

3. The driving unit of the wearable device of claim 1, wherein the auxiliary frame is rotatably connected to a side of the motor housing, and the heat dissipation channel is at least partially positioned on another side of the motor housing.

4. The driving unit of the wearable device of claim 3, wherein the heat dissipation channel comprises:
a heat dissipation frame at least partially surrounding the motor in the motor housing; and
a plurality of heat dissipation plates extending from the heat dissipation frame to the outside of the motor housing and spaced apart at predetermined intervals.

5. The driving unit of the wearable device of claim 4, wherein the heat dissipation frame is configured to transmit the heat generated from the motor to at least some of the heat dissipation plates, and the heat dissipation plates are configured for discharging the heat received from the heat dissipation frame into air.

6. The driving unit of the wearable device of claim 5, further comprising:
a heat dissipation plate housing at least partially enclosing the heat dissipation plates,
wherein the heat dissipation plate housing and the motor housing are connected integrally.

7. The driving unit of the wearable device of claim 3, wherein the driving unit is configured so that:
the heat generated from the motor is to be discharged to one side of the motor housing through a metal gear connecting the motor and the auxiliary frame and discharged to the other side of the motor housing through at least the heat dissipation channel.

8. The driving unit of the wearable device of claim 7, wherein the auxiliary frame comprises a metal inclusive torque sensor connected to the metal gear, and the heat generated from the motor is to be transmitted to the metal torque sensor through at least the metal gear.

9. The driving unit of the wearable device of claim 8, wherein the auxiliary frame and the metal inclusive torque sensor are formed integrally to prevent and/or reduce moisture from penetrating from outside.

10. A power supply unit of a wearable device, the power supply unit comprising:
a waist plate configured for supporting a lower back of a user;
a battery housing configured for accommodating a battery and a resistor capable of supplying and controlling power to the driving unit of claim 1; and
a heat dissipation channel configured for discharging heat generated from the battery and the resistor to outside of the battery housing.

11. The power supply unit of the wearable device of claim 10, wherein the heat dissipation channel comprises a plurality of heat dissipation plates spaced apart at predetermined intervals, and is configured so that air is allowed to flow between the plurality of heat dissipation plates.

12. A wearable device comprising:
the driving unit of claim 1;
a power supply unit; and
a main frame unit configured for connecting the driving unit of the wearable device and the power supply unit of the wearable device and accommodating at least part of a body of a user therein.
